(19) United States
(12) Patent Application Publication
(10) Pub. No.: US 2011/0234012 A1
(43) Pub. Date: Sep. 29, 2011

(54) POWER RECEIVING APPARATUS AND WIRELESS POWER TRANSCEIVING SYSTEM

(75) Inventors: Kang-hyun YI, Chungcheongnam-do (KR); Sung-jin CHOI, Gunpo-si (KR); Pankaj AGARWAL, Suwon-si (KR); Joon-hyun YANG, Suwon-si (KR)

(73) Assignee: SAMSUNG ELECTRONICS CO., LTD., Suwon-si (KR)

(21) Appl. No.: 12/879,769

(22) Filed: Sep. 10, 2010

(30) Foreign Application Priority Data
Mar. 29, 2010 (KR) 10-2010-0027872

(51) Int. Cl. H02J 17/00

(52) U.S. Cl. 307/104

(57) ABSTRACT

A wireless power transceiving system includes a power transmitting apparatus which converts power into a resonance wave and transmits the resonance wave, and a power receiving apparatus which receives the transmitted resonance wave and converts the resonance wave into DC power using a series resonant rectifier circuit which is impedance matched with impedance of the power receiving apparatus at a frequency of the resonance wave.

### CROSS-REFERENCE TO RELATED APPLICATION

This application claims priority from Korean Patent Application No. 10-2010-0027872, filed Mar. 29, 2010, in the Korean Intellectual Property Office, the disclosure of which is incorporated herein by reference in its entirety.

### BACKGROUND

1. Field

Apparatuses and methods consistent with exemplary embodiments relate to a power receiving apparatus and a wireless power transceiving system, and more particularly, to a power receiving apparatus and a wireless power transceiving system, which adjust an impedance of a parasitic inductance of a rectifying circuit operating at a high frequency using a capacitive element, thereby improving power transmission efficiency.

2. Description of the Related Art

With the development of information and communication technologies, various types of mobile electronic products are coming into the market and thus the number of electronic products carried around by users is rapidly increasing.

Such mobile electronic products are operated with a cell embedded therein. Thus, there have been research and development related to charging the cell in mobile electronic products. Particularly, a wireless power transmission technique for supplying power using an electromagnetic resonance method without using electric wires has been developed.

As a consequence, it became possible to design a resonator having 80% efficiency in electromagnetic resonance method, but increasing the efficiency of a circuit further is difficult. Therefore, it is difficult to improve the entire efficiency of a wireless power transceiving system.

Specifically, in a related art wireless power transmission method, wirelessly transmitted power is rectified using a full wave rectifier. Since a circuit is operated at MHz range in the electromagnetic resonance method, it is difficult to achieve high efficiency in a related art rectifying circuit.

More specifically, a related art rectifying circuit rectifies power using a diode. However, at high frequency, the impedance of the diode increases due to a parasitic component, that is, a parasitic inductance. Consequently, the rectifying circuit does not rectify a high frequency alternating current (AC) input voltage properly. In particular, since the AC component remaining to be rectified results in a loss, the entire efficiency of the wireless power transceiving system deteriorates.

Also, if a load connected to an output of the rectifying circuit changes from a maximum level to a minimum level, the impedance changes due to the parasitic component and the load, and thus the level of rectified voltage changes. In particular, in the case of a resonance type rectifying circuit, as the load decreases, the rectified voltage increases. In this state, if a DC/DC converter is connected to an output of the rectifying circuit, the load of the DC/DC converter increases and thus the efficiency further deteriorates.

Accordingly, there is a need for a rectifying circuit capable of improving efficiency of a wireless power transceiving system and also capable of outputting rectified voltage at a consistent level even if a load changes.

### SUMMARY

Exemplary embodiments address at least the above problems and/or disadvantages and other disadvantages not described above. Also, an exemplary embodiment is not required to overcome the disadvantages described above, and an exemplary embodiment may not overcome any of the problems described above.

Exemplary embodiments provide a power receiving apparatus and a wireless power transceiving system which adjust impedance of a parasitic inductance of a rectifying circuit operating at a high frequency using a capacitive element, thereby improving power transmission efficiency.

Exemplary embodiments also provide a power receiving apparatus and a wireless power transceiving system which are capable of maintaining an output voltage from a rectifying circuit at a consistent level even if a size of load is changed.

According to an aspect of an exemplary embodiment, a wireless power transceiving system includes: a power transmitting apparatus which converts power into a resonance wave and transmits the resonance wave, and a power receiving apparatus which receives the transmitted resonance wave and converts the resonance wave into direct current (DC) power using a series resonant rectifier circuit which is impedance matched with a frequency of the resonance wave.

The power receiving apparatus may include: a reception resonator which receives the transmitted resonance wave, a rectifier which rectifies the resonance wave into a DC, and a capacitive element which is connected between the reception resonator and the rectifier in series and adjusts a characteristic impedance of the power receiving apparatus.

The rectifier may be a full wave rectifier.

The rectifier may include: a first diode which has an anode connected to the capacitive element and a cathode connected to a first output node, a second diode which has a cathode connected to the capacitive element and an anode connected to a second output unit, a third diode which has an anode connected to the reception resonator and a cathode connected to the first output node, and a fourth diode which has a cathode connected to the reception resonator and an anode connected to the second output node.

The power receiving apparatus may further include a smoothing circuit which is connected to the first output node and the second output node in parallel.

The power receiving apparatus may further include an adjuster which adjusts a capacitance of the capacitive element so as to adjust the characteristic impedance of the power receiving apparatus according to a size of a load connected to the first output node and the second output node in parallel.

The power transmitting apparatus may include: a power supply unit which supplies power, and a reception resonator which converts the supplied power into a resonance wave and transmits the resonance wave to the power receiving apparatus.

According to an aspect of another exemplary embodiment, a power receiving apparatus includes: a reception resonator which receives a resonance wave transmitted from an external source, a rectifier which rectifies the received resonance wave into DC power, a load unit which consumes the rectified DC power, and a capacitive element which is connected between the reception resonator and the rectifier in series and adjusts a characteristic impedance of the power receiving apparatus.

The rectifier may be a full wave rectifier.

The rectifier may include: a first diode which has an anode connected to the capacitive element and a cathode connected to a first output node, a second diode which has a cathode connected to the capacitive element and an anode connected to a second output unit, a third diode which has an anode connected to the reception resonator and a cathode connected to the first output node, and a fourth diode which has a cathode connected to the reception resonator and an anode connected to the second output node.

The power receiving apparatus may further include a smoothing circuit which is connected to the first output node and the second output node in parallel.

The power receiving apparatus may further include an adjuster which measures a load size of the load unit and adjusts a capacitance of the capacitive element so as to adjust the characteristic impedance of the power receiving apparatus according to the measured load size.

The capacitive element may be at least one of a capacitor, a variable capacitor, and a circuit in which a plurality of groups each including a variable capacitor and a switch element connected to each other in parallel are connected to one another in series.

The power receiving apparatus may be at least one of a remote controller and three-dimensional (3D) glasses which communicate with a display apparatus wirelessly.

### BRIEF DESCRIPTION OF THE DRAWINGS

The above and/or other aspects will be more apparent by describing in certain exemplary embodiments, with reference to the accompanying drawings, in which:

FIG. 1 is a view illustrating a wireless power transceiving system according to an exemplary embodiment;

FIG. 2 is a block diagram illustrating the power transmitting apparatus of FIG. 1 in detail;

FIG. 3 is a block diagram illustrating the power receiving apparatus of FIG. 1 in detail;

FIG. 4 is a circuit diagram of the wireless power transceiving system according to an exemplary embodiment;

FIG. 5 is a view illustrating an equivalent circuit of a diode operating at a high frequency;

FIG. 6 is a circuit diagram of the power receiving apparatus reflecting a diode equivalent circuit during a half period of AC power;

FIG. 7 is a view illustrating an equivalent circuit of the circuit of FIG. 6;

FIG. 8 is a graph illustrating a voltage gain curve of the power receiving apparatus according to an exemplary embodiment;

FIG. 9 is a view illustrating a rectified voltage according to a frequency of the power receiving apparatus according to an exemplary embodiment; and

FIG. 10 is a circuit diagram of a power receiving apparatus according to another exemplary embodiment.

### DETAILED DESCRIPTION OF EXEMPLARY EMBODIMENTS

Certain exemplary embodiments are described in greater detail with reference to the accompanying drawings.

In the following description, like reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, functions or elements known in the related art are not described in detail since they would obscure the invention with unnecessary detail.

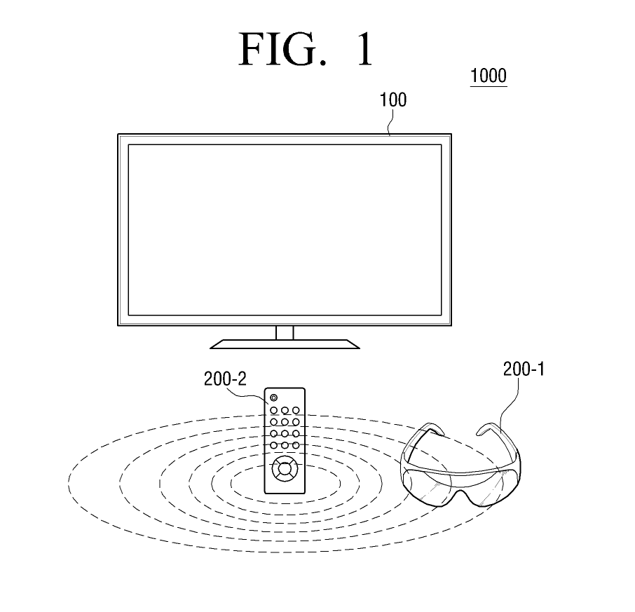

FIG. 1 is a view illustrating a wireless power transceiving system according to an exemplary embodiment.

Referring to FIG. 1, a wireless power transceiving system 1000 includes a power transmitting apparatus 100 and a power receiving apparatus 200. As shown in FIG. 1, the power transmitting apparatus 100 may be a display apparatus such as a television or an electronic album and the power receiving apparatus 200 may be an apparatus that communicates with a display apparatus wirelessly, such as 3D glasses 200-1 or a remote controller 200-2.

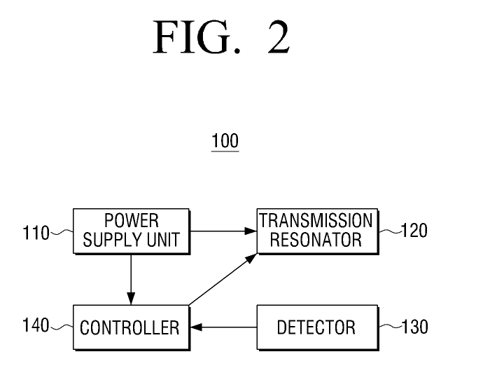

The power transmitting apparatus 100 converts power into a resonance wave and transmits the resonance wave. Detailed configuration and operation of the power transmitting apparatus 100 are explained below with reference to FIG. 2.

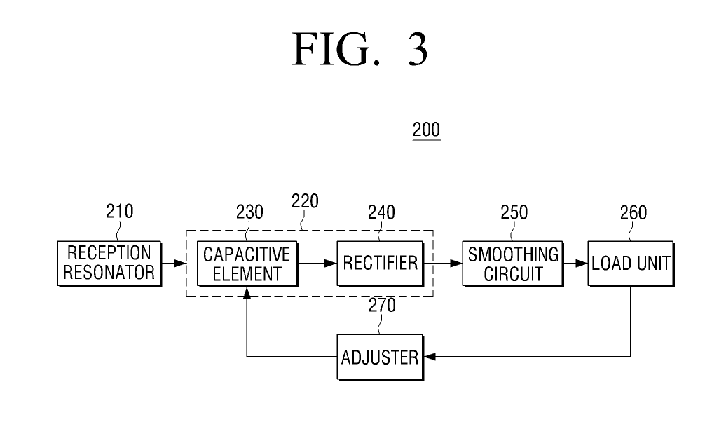

When the power receiving apparatus 200 is located in the proximity of the power transmitting apparatus 100, the power receiving apparatus 200 receives the power wirelessly using the resonance wave generated by the power transmitting apparatus 100. Detailed configuration and operation of the power receiving apparatus 200 are described below with reference to FIG. 3.

In FIG. 1, the power receiving apparatus 200 is located in the proximity of the power transmitting apparatus 100 with a cell included therein. The power receiving apparatus 200 charges the cell using the supplied resonance wave in the proximity of the power transmitting apparatus 100 and operates using the power charged in the cell at a long distance from the power transmitting apparatus 100. Although the power transmitting apparatus 100 is an apparatus that can communicate with the power receiving apparatus 200 wirelessly, the power transmitting apparatus 100 may be a power cradle that only supplies power to the power receiving apparatus 200.

FIG. 2 is a block diagram illustrating the power transmitting apparatus 100 of FIG. 1 in detail. Referring to FIG. 2, the power transmitting apparatus 100 includes a power supply unit 110, a transmission resonator 120, a detector 130, and a controller 140.

The power supply unit 110 provides components of the power transmitting apparatus 100 with power, under control of the controller 140, as described in detail below. More specifically, the power supply unit 110 receives power from an external source and converts the power into a voltage to be supplied to the components of the power transmitting apparatus 100, and supplies the converted power to the components.

The transmission resonator 120 converts the supplied power into a resonance wave and transmits the resonance wave to the power receiving apparatus 200. The resonance wave refers to an electromagnetic wave having a resonant frequency, as for example, a resonant frequency in a range of 1 MHz to 10 MHz.

More specifically, the transmission resonator 120 is a resonance circuit that includes an inductance L and a capacitance C and has a resonant frequency. The transmission resonator 120 is activated by the power supplied from the power supply unit 110 and generates a resonance wave having a resonant frequency so that a reception resonator 210 of the power receiving apparatus 200 to generates resonance. The reception resonator 210 receives the power wirelessly through the resonance wave generated by the transmission resonator 120.

The detector 130 detects whether the power receiving apparatus 200 is located within a predetermined range of the power transmitting apparatus 100. More specifically, the detector 130 detects whether the power receiving apparatus 200 is located within a predetermined range by using a wireless communication method, such as radio frequency (RF) communication or Bluetooth or using a sensor, such as a web camera.

The controller 140 controls the components of the power transmitting apparatus 100. More specifically, if the power receiving apparatus 200 is located within the predetermined range of the power transmitting apparatus 100, the controller 140 may control the power supply unit 110 and the transmission resonator 120 to generate the resonance wave having the resonant frequency.

The controller 140 may control the power supply unit 110 and the transmission resonator 120 to generate the resonance wave only if a request for power transmission is received from the power receiving apparatus 200. More specifically, even if the power receiving apparatus 200 is located within the predetermined range, the controller 140 may control the power supply unit 110 and the transmission resonator 120 to generate the resonance wave only upon receiving the request for power transmission from the power receiving apparatus 200.

FIG. 3 is a block diagram illustrating the power receiving apparatus 200 of FIG. 1 in detail. Referring to FIG. 3, the power receiving apparatus 200 includes the reception resonator 210, a series resonant rectifier circuit 220, a smoothing circuit 250, a load unit 260, and an adjuster 270.

The reception resonator 210 receives a resonance wave transmitted from an external source. More specifically, the reception resonator 210 receives the resonance wave generated by the power transmitting apparatus 100 and generates AC power.

The series resonant rectifier circuit 220 rectifies the AC power generated by the reception resonator 210 into DC power. More specifically, the series resonant rectifier circuit 220 includes a capacitive element 230 and a rectifier 240.

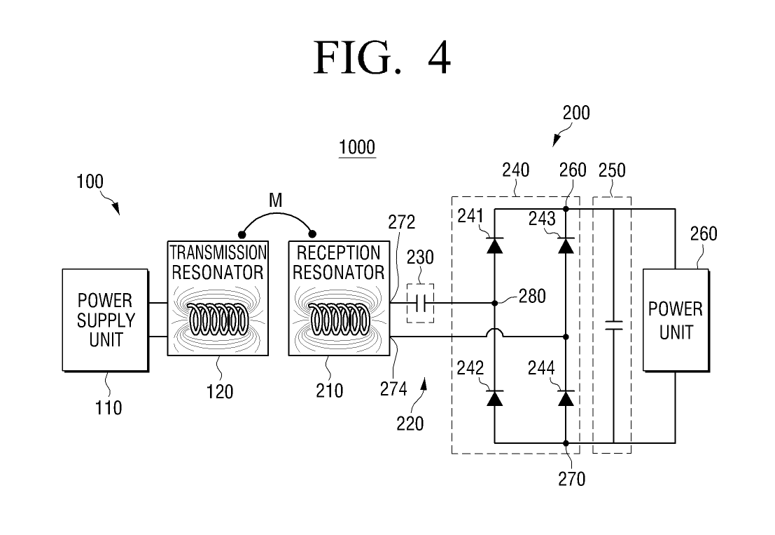

The rectifier 240 rectifies the AC power generated by the reception resonator 210 into the DC power. The rectifier 240 may be a full wave rectifier that includes four diodes 241, 242, 243, 244. A detailed circuit configuration of the rectifier 240 is described below with reference to FIG. 4.

The capacitive element 230 is connected between the reception resonator 210 and the rectifier 240 in series, and is able to adjust impedance in the power receiving apparatus 200. More specifically, the capacitive element 230 has a capacitance value to remove or compensate impedance generated by a parasitic inductance of the diodes 241, 242, 243, 244, when the circuit operates at a high frequency. The capacitive element 230 may have a capacitance value which the impedance matched with the impedance of the power receiving apparatus 200. The capacitive element 230 may include a capacitor, a variable capacitor, a circuit in which a plurality of groups each having a variable capacitor and a switch element connected with each other in parallel are connected to one another in series, or a circuit in which a plurality of groups each having a variable capacitor and a switch element connected to each other in series are connected to one another in parallel.

The smoothing circuit 250 smoothes the power rectified by the series resonant rectifier circuit 220. More specifically, the smoothing circuit 250 is connected to an output of the series resonant rectifier circuit 220 in series and smoothes the output power output from the series resonant rectifier circuit 220.

The load unit 260 consumes the rectified DC power. More specifically, the load unit 260 receives the DC power converted by the series resonant rectifier circuit 220 and smoothed by the smoothing circuit 250, and performs a function of the power receiving apparatus 200. The load unit 260 may include a cell and may charge the cell using the rectified DC power.

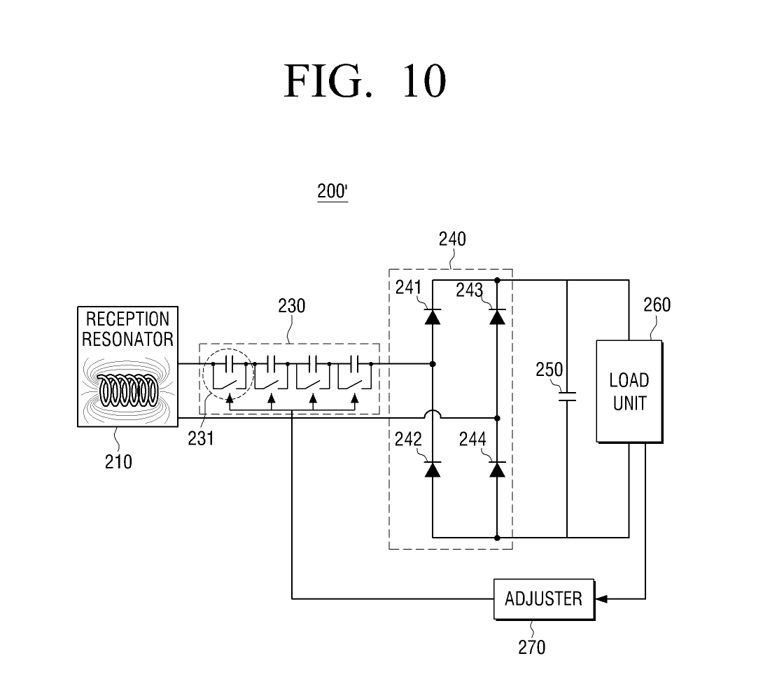

The adjuster 270 adjusts the voltage output from the series resonant rectifier circuit 220 to be maintained at a consistent level. More specifically, the adjuster 270 measures the amount of a load of the load unit 260 and adjusts the capacitance value of the capacitive element 230 according to the measured amount of the load, thereby maintaining the voltage output from the series resonant rectifier circuit 220 at a consistent level. A detailed operation of the adjuster 270 is described below with reference to FIG. 10.

FIG. 4 is a circuit diagram of the wireless power transceiving system 1000 according to an exemplary embodiment.

Referring to FIG. 4, the power transmitting apparatus 100 includes the power supply unit 110 and the transmission resonator 120, and generates the resonance wave to transmit the power wirelessly. The detailed operation of the power transmitting apparatus 100 is described above with reference to FIG. 2.

The power receiving apparatus 200 shown in FIG. 4 includes the reception resonator 210, the series resonant rectifier circuit 220, the smoothing circuit 250, and the load unit 260.

The reception resonator 210 receives the resonance wave generated by the transmission resonator 120 and generates the AC power in response to the received resonance wave.

The smoothing circuit 250 may be a capacitive element that is connected to a first output node 260 and a second output node 270 in parallel, and smoothes the power rectified by the series resonant rectifier circuit 220.

The series resonant rectifier circuit 220 receives the AC power generated with the received resonance wave from the reception resonator 210, and rectifies the received AC power into the DC power. More specifically, the series resonant rectifier circuit 220 includes the capacitive element 230 and the rectifier 240.

The capacitive element 230 adjusts the impedance in the power receiving apparatus 200 by using a predetermined capacitance value. In FIG. 4, the capacitive element 230 is a capacitor connected to a first terminal 272 of the reception resonator 210 and to the rectifier 240 at a first input node 280. However, according to another exemplary embodiment, the capacitive element 230 may include a different element and a different circuit.

The rectifier 240 includes four diodes 241, 242, 243, 244. More specifically, the rectifier 240 may include a first diode 241 having an anode connected to the capacitive element 230 at the first input node 280 and a cathode connected to a first output node 260, a second diode 242 having a cathode connected to the capacitive element 230 at the first input node 280 and an anode connected to a second output node 270, a third diode 243 having an anode connected to a second terminal 274 of the reception resonator 210 and a cathode connected to the first output node 260, and a fourth diode having a cathode connected to the second terminal 274 of the reception resonator 210 and an anode connected to the second output node 270.

The first output node 260 is a node at which the cathode of the first diode 241 is connected to the cathode of the third diode 243. The second output node 270 is a node at which the anode of the second diode 242 is connected to the anode of the fourth diode 244.

The diode is a circuit element that closes or opens according to a voltage value at each end of the diode. An ideal diode transmits electric current without power consumption if the voltage at both ends is greater than or equal to a predetermined value, and does not transmit if the voltage at both ends is less than the predetermined value.

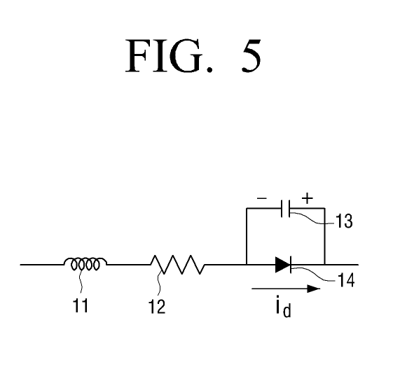

However, the real diode has a parasitic inductance, a parasitic capacitance, and a parasitic resistance, and the diode reflecting such parasitic components may be modeled as shown in FIG. 5.

More specifically, the modeled diode includes a parasitic inductor 11, a parasitic resistor 12, a parasitic capacitor 13, and an ideal diode 14. In general, the parasitic components have small impedance values, which can be neglected, when the circuit operates at low frequency. However, the impedance values of the inductor and the capacitor vary according to an operation frequency, and the parasitic components have considerable impedance values when the circuit operates at high frequency. In particular, since the rectifying circuit in the power receiving apparatus 200 rectifies the AC power having frequency in MHz range, the impedance generated by the parasitic inductance in the diode needs to be removed.

Accordingly, the power receiving apparatus 200 adjusts the impedance by adjusting the capacitance value of the capacitive element 230, thereby removing the impedance caused by the parasitic inductance of the diode.

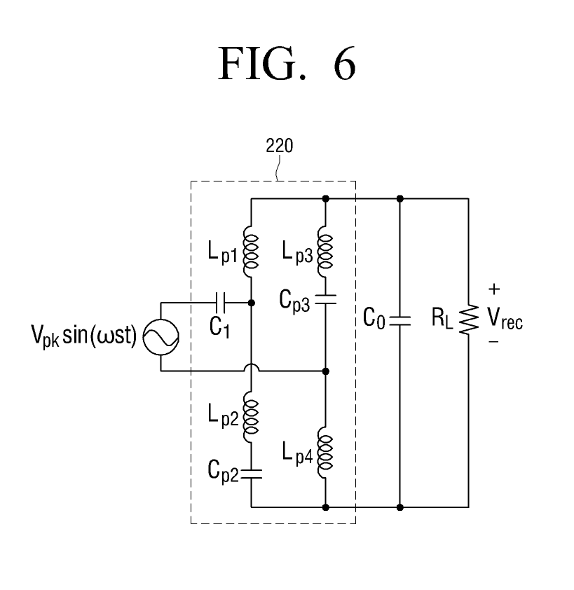

A detailed operation of adjusting the impedance of the power receiving apparatus 200 using the capacitive element 230 is described with reference to FIGS. 6 to 9.

FIG. 6 is a circuit diagram of the power receiving apparatus reflecting an equivalent circuit of a diode during a half period of AC power. More specifically, if the AC power generated in the reception resonator 210 has a phase ranging from 0° to 180°, only the parasitic inductances L_{P1} and L_{P4} affect the circuit in a diode modeled for the first diode 241 and the fourth diode 244 (the ideal diode 14 closes). The parasitic inductances L_{P2} and L_{P3} and the parasitic capacitances C_{P2} and C_{P3} affect the circuit in a diode modeled for the second diode 242 and the third diode 243 (the ideal diode 14 is opened). In FIG. 6, C₁ represents capacitance of the capacitive element 230, Cₒ represents capacitance of the smoothing circuit 250, and R_{L} represents resistance of the load unit 240. The parasitic resistor is not illustrated in FIG. 5 for the convenience of explanation since the resistance of the resistor does not change according to the frequency.

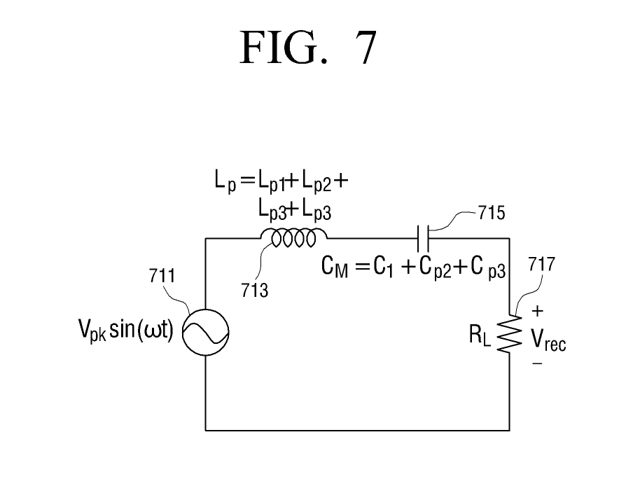

Various inductors and capacitors illustrated in FIG. 6 may be represented by an equivalent circuit shown in FIG. 7. Specifically, inductor 713 represents circuit parasitic inductance L_{P}=L_{P1}+L_{P2}+L_{P3}+L_{P4}, a capacitor 715 represents the series resonant rectifier circuit capacitance C_{M}=C₁+C_{P2}+C_{P3}, a resistor 717 represents the load resistance R_{L}, and a voltage device 711 represents the AC voltage V_{P}=V_{PK} sin(ωt).

A ratio of an output voltage value V_{rec} of the series resonant rectifier circuit 220 to the AC voltage value V_{P} generated by the reception resonator 210 may be obtained using the equivalent circuit of FIG. 7 according to Equation 1:

$$\frac{{V}_{rec}}{{V}_{p}} = \frac{1}{\sqrt{[ {( {π}^{2} / 8 Q ( ω / {ω}_{0} - {ω}_{0} / ω ) )}^{2} + 1 ]}} \qquad [ Equation 1 ]$$

wherein ω₀ is a resonant frequency of the equivalent circuit of FIG. 7, ω is a frequency of a resonance wave, ω₀=1/\sqrt{LₚC_{M}}), Q=(\sqrt{Lₚ/C_{M}})/R_{0C}, and

$${R}_{0 C} = \frac{8}{{π}^{2}} {R}_{L} .$$

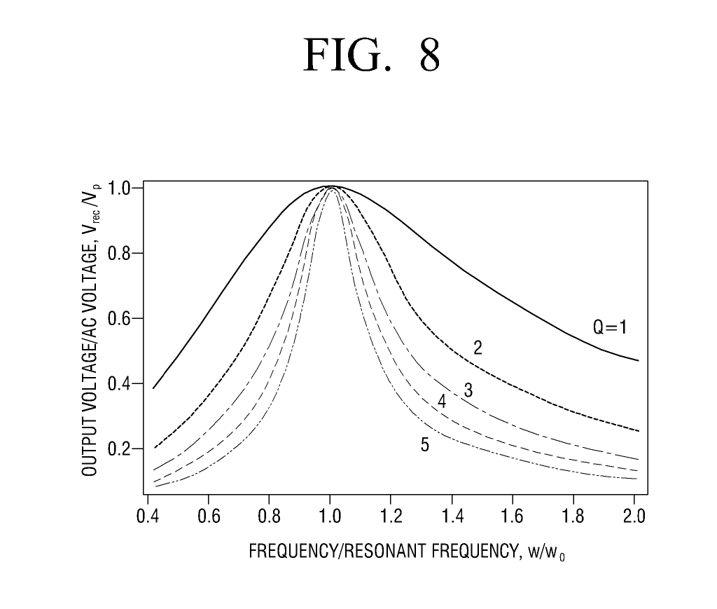

FIG. 8 illustrates a voltage gain curve of the power receiving apparatus according to an exemplary embodiment based on Equation 1.

X-axis represents a ratio of frequency ω of the AC voltage V_{P} generated by the reception resonator 210 to the resonant frequency ωₒ. Y-axis represents a ratio of the output voltage value V_{rec} of the series resonant rectifier circuit 220 to the AC voltage V_{P} generated by the reception resonator 210.

Referring to FIG. 8, if the resonant frequency ω₀ of the power receiving apparatus 200 is identical to the frequency ω of the AC voltage V_{P} generated by the reception resonator 210, a maximum gain is obtained. As shown by Equation 1, since a Q-factor and a resonant frequency ω₀ of the power receiving apparatus 200 may be adjusted using the capacitance of the capacitive element 230, the power receiving apparatus may be implemented by adjusting the capacitance value of the capacitive element 230 according to a condition of the system.

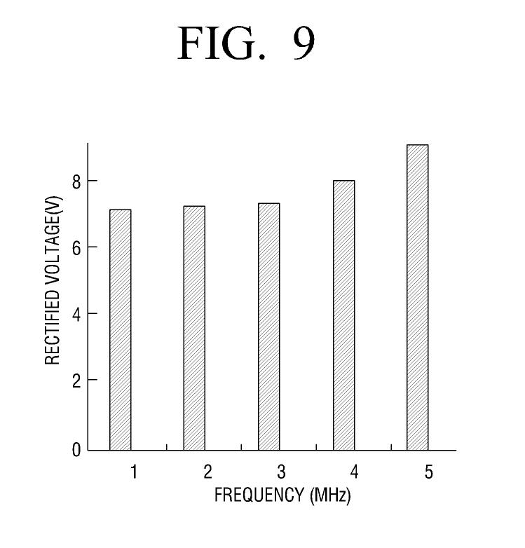

FIG. 9 is a view illustrating a level of rectified voltage varying according to a change in the frequency of the power receiving apparatus according to an exemplary embodiment. More specifically, FIG. 9 illustrates data obtained by applying values of Table 1 to the power receiving apparatus 200 shown in FIG. 4:

TABLE 1

| Source Frequency, ω | 1 MHz~5 MHz | |
|---|---|---|
| Generated AC Voltage, V_{P} | 10sinωt | |
| Parasitic Inductance (L_{P}) | 32 | nH |
| C_{M} | 4.7 | nF |

Based values of the Table 1, the resonant frequency ωₒ of the power receiving apparatus 200 may be approximately 13 MHz while the frequency ω of AC power generated by the reception resonator 210 may be in the range from 1 MHz to 5 MHz. More specifically, referring to FIG. 9, as the frequency ω of the AC power is closer to the resonant frequency ωₒ of the power receiving apparatus 200, the output value is higher.

FIG. 10 is a circuit diagram of a power receiving apparatus 200′ according to another exemplary embodiment.

Comparing FIGS. 4 and 10, a capacitive element 230 of FIG. 10, the capacitive element 230 includes a plurality of capacitors and a plurality of switch elements. The capacitive element 230 may have different capacitance values according to how the plurality of switch elements is connected. Although the capacitive element 230 of FIG. 10 is configured by connecting in series four groups 231 each including a capacitor and a switch element connected to each other in parallel, more or fewer units, each including the capacitor and the switch element connected to each other in parallel, may be provided, or units each including a capacitor and a switch element connected to each other in series may be connected to one another in parallel.

As described above, because the capacitive element 230 may have various capacitance values, the adjuster 270 may adjust the capacitance values of the capacitive element 230 according to the load condition and maintain the output voltage output from the series resonant rectifier circuit 220 at a consistent level. More specifically, since the impedance value changes if the capacitance value of the capacitive element 230 changes, the adjuster 270 can adjust the output voltage of the series resonant rectifier circuit 220 to be maintained at a consistent level. The capacitance value may be adjusted, for example, by opening and closing selected switches.

Accordingly, the power receiving apparatus 200 can maintain the output voltage value by changing the impedance in response to the change in the load.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A wireless power transceiving system comprising:
a power transmitting apparatus which converts power into a resonance wave and transmits the resonance wave; and
a power receiving apparatus which receives the transmitted resonance wave and converts the resonance wave into direct current (DC) power using a series resonant rectifier circuit which is impedance matched with impedance generated in the power receiving apparatus by parasitic components at a frequency of the resonance wave.

2. The wireless power transceiving system as claimed in claim 1, wherein the power receiving apparatus comprises a reception resonator which receives the transmitted resonance wave, and
wherein the series resonant rectifier circuit comprises:
a rectifier which rectifies the resonance wave into the DC power; and
a capacitive element which is connected in series between the reception resonator and the rectifier and adjusts the impedance of the power receiving apparatus.

3. The wireless power transceiving system as claimed in claim 2, wherein the rectifier comprises a full wave rectifier.

4. The wireless power transceiving system as claimed in claim 2, wherein the rectifier comprises:
a first diode having an anode connected to the capacitive element and a cathode connected to a first output node;
a second diode having a cathode connected to the capacitive element and an anode connected to a second output node;
a third diode having an anode connected to the reception resonator and a cathode connected to the first output node; and
a fourth diode having a cathode connected to the reception resonator and an anode connected to the second output node.

5. The wireless power transceiving system as claimed in claim 4, wherein the power receiving apparatus further comprises a smoothing circuit which is connected in parallel to the first output node and the second output node.

6. The wireless power transceiving system as claimed in claim 5, wherein the power receiving apparatus further comprises an adjuster which adjusts a capacitance value of the capacitive element to adjust the impedance of the power receiving apparatus according to a size of a load connected in parallel to the first output node and the second output node.

7. The wireless power transceiving system as claimed in claim 1, wherein the power transmitting apparatus comprises:
a power supply unit which supplies power; and
a transmission resonator which converts the supplied power into the resonance wave and transmits the resonance wave to the power receiving apparatus.

8. A power receiving apparatus comprising:
a reception resonator which receives a resonance wave transmitted from an external source;
a rectifier which converts the received resonance wave into direct current (DC) power;
a load unit which consumes the DC power; and
a capacitive element which is connected in series between the reception resonator and the rectifier and adjusts impedance of the power receiving apparatus.

9. The power receiving apparatus as claimed in claim 8, wherein the rectifier comprises a full wave rectifier.

10. The power receiving apparatus as claimed in claim 8, wherein the rectifier comprises:
a first diode having an anode connected to the capacitive element and a cathode connected to a first output node;
a second diode having a cathode connected to the capacitive element and an anode connected to a second output node;
a third diode having an anode connected to the reception resonator and a cathode connected to the first output node; and
a fourth diode having a cathode connected to the reception resonator and an anode connected to the second output node.

11. The power receiving apparatus as claimed in claim 10, further comprising a smoothing circuit which is connected in parallel to the first output node and the second output node.

12. The power receiving apparatus as claimed in claim 8, further comprising an adjuster which measures a load size of the load unit and adjusts a capacitance value of the capacitive element to adjust the impedance of the power receiving apparatus according to the measured load size.

13. The power receiving apparatus as claimed in claim 8, wherein the capacitive element comprises at least one of a capacitor, a variable capacitor, and a circuit in which a plurality of groups each including a variable capacitor and a switch element connected to each other in parallel is connected to one another in series.

14. The power receiving apparatus as claimed in claim 8, wherein the power receiving apparatus comprises at least one of a remote controller and three-dimensional glasses which communicate wirelessly with a display apparatus.

15. An apparatus comprising:
a first device which converts electric power into a resonance wave and wirelessly transmits the resonance wave; and
a second device which receives the transmitted resonance wave and converts the resonance wave into direct circuit (DC) power, wherein the second device is impedance matched with impedance generated in the second device by parasitic components at a frequency of the resonance wave.

16. The apparatus as claimed in claim 15, wherein the second device comprises:
a capacitive element which is connected in series with the reception resonator and adjusts the impedance of the power receiving apparatus;
a first diode having an anode connected to the capacitive element and a cathode connected to a first output node;
a second diode having a cathode connected to the capacitive element and an anode connected to a second output node;
a third diode having an anode connected to the reception resonator and a cathode connected to the first output node; and
a fourth diode having a cathode connected to the reception resonator and an anode connected to the second output node,
wherein the first, second, third, and fourth diodes generate the parasitic components at the frequency of the resonance wave, and
a capacitive value of the capacitive element is specified to compensate the impedance generated in the second device by the parasitic components.

17. The apparatus as claimed in claim 16, wherein the capacitive element comprises capacitors connected in parallel to one another and each connected in series to a corresponding switch element.

18. The apparatus as claimed in claim 17, wherein the second device further comprises:
an adjuster which adjusts the capacitance value of the capacitive element by turning on and off the capacitors by closing and opening the corresponding switching elements to regulate the impedance of the second device.
